(19) United States
(12) Patent Application Publication
(10) Pub. No.: US 2010/0088121 A1
(43) Pub. Date: Apr. 8, 2010

(54) MEDICAL INFORMATION NOTIFICATION SYSTEM USING SECURE WIRELESS AND/OR WIRED COMMUNICATION

(75) Inventors: George Shih, New York, NY (US); Yonghuan Cao, Morrisville, NC (US)

Correspondence Address: WOLF GREENFIELD & SACKS, P.C., 600 ATLANTIC AVENUE, BOSTON, MA, 02210-2206, US

(73) Assignee: Vitesso, New York, NY (US)

(21) Appl. No.: 12/604,789

(22) Filed: Oct. 23, 2009

Related U.S. Application Data
(63) Continuation of application No. PCT/US2008/004986, filed on Apr. 18, 2008.
(60) Provisional application No. 60/926,111, filed on Apr. 25, 2007.
(60) Provisional application No. 60/926,186, filed on Apr. 25, 2007.

(51) Int. Cl. G06Q 50/00; G06Q 10/00; G06F 3/048; G06F 15/16

(52) U.S. Cl. 705/3; 715/780; 709/206

(57) ABSTRACT

A system for reporting medical information to healthcare provider users may require users to acknowledge receipt of information. Information may be sent using a secure instant messaging (SIM) protocol, and users may acknowledge receipt, e.g., by sending a message, or clicking on a uniform resource locator (URL) or button included in the information. Unacknowledged information may be re-sent at designated time intervals, and may have different levels of urgency indicated in the message. Acknowledgement may be tracked by the system, e.g., by recording the user and timestamp of acknowledgement. Feeds or syndications (e.g., RSS, RDF, Atom, etc.) may be used to provide medical information, allowing users to subscribe to feeds for one or more patients. Feeds may be continuously aggregated and updated with the most recent information for each of the patients. Users can easily distinguish new information from information already accessed, thereby allowing the healthcare provider to efficiently sort through the medical data.

This application is a continuation of PCT application PCT/US2008/0004986, filed Apr. 18, 2008, and claims the benefit of U.S. Provisional applications 60/926,186 and 60/926,111, both filed Apr. 25, 2007.

### BACKGROUND

The electronic medical record has advanced dramatically in the last decade and many hospitals rely either exclusively on them or in conjunction with a traditional paper-based medical record. The electronic medical record typically is based on a server-client model, where the server keeps all the information archived about the patient's information and gets updated on a continual basis. In this model, the healthcare provider (e.g., physician, nurse, physician assistant, etc.) typically uses a client interface either by a desktop computer, terminal, laptop computer, or portable digital assistant (PDA) to access the information. The client interface usually allows querying for patients based on some kind of identifier, usually either a patient medical record number (MRN) or by patient name. This type of conventional server-client model may track which doctors access which particular patient's medical record, but does not always keep track of which parts of that medical record has been seen by a particular healthcare provider.

Delivery of critical medical testing results or other information is an important part of medical care, but has been difficult to fully realize due to the complexity of the problem. While many results can easily be determined to be critical, other results may not be perceived as urgent but in fact can result in life-saving or life-changing outcomes if not received and used at an appropriate interval. Services delivering such results (e.g., laboratory, radiology, pathology, etc.) may have systems or processes in place for communicating critical results, but often, results which appear to be normal or only slightly abnormal may not be communicated with the same urgency, but may in fact have important consequences if not acted upon in a reasonable fashion. These diagnostic services often have incomplete clinical information when performing these tests, and only the referring physicians and other members of the healthcare provider team may have the necessary information to interpret tests results in the context of a particular patient. For example, a slightly low white blood cell count may not be urgent or critically important information in a patient recovering from leukemia where a low count may be expected, but may be vitally important in someone with undiagnosed human immunodeficiency virus (HIV) who presents with some other illness.

### SUMMARY OF INVENTION

Currently, the reporting mechanisms used by medical diagnostic services and other generators of medical information assume that the referring physician or healthcare team will receive and/or seek out test results and other information at appropriate time intervals. Consequently, test results have traditionally been received by healthcare providers in an asynchronous fashion, without verification that they have ever been received, except for the most time-sensitive critical of results in which case a phone call is usually made with read-back information. Occasionally, non-time-sensitive results are not received until much later, for whatever reason, and patient care may suffer as a result.

The inventors have appreciated that a system which can efficiently deliver results, both critical and otherwise, is crucial for appropriate patient care. Such a system should preferably require that these results be acknowledged, verifying that the appropriate referring physician and other healthcare providers have received this information, as only they alone—not the diagnostic services—may be able to determine how relevant or crucial that information is for a particular patient. Importantly, this system should be able to deliver results to multiple healthcare providers since, as is sometimes the case, only one of these healthcare providers—the expert in a particular subspecialty—may be able to appropriately interpret and act on these results.

Aspects of the invention provide a method for automatically delivering (optionally secure) messages within the healthcare environment to one or more healthcare providers that are associated with a particular patient (or the patient him/herself), and requiring acknowledgement of receipt of the medical information by the healthcare providers/patients. Messages may be sent to healthcare provider/patient users only when the users are logged into a messaging system, such as an instant messaging system or other communications arrangement by which the messaging system may confirm that a user is actively linked into the system and is capable of receiving messages.

In one illustrative embodiment, aspects of the invention provide direct secure communications between a messaging system and healthcare provider/patient users for delivering messages regarding results from medical or healthcare-related services, such as radiology and laboratory test results, or other medical information such as clinician notes, consultation notes, vital signs, procedural or operating reports, medication updates, allergy warnings, physical exam notes, voice or sound notes, images, video clips. The messaging system automatically delivers these results to the appropriate referring physician and other healthcare providers associated with the patient, as often is the case that multiple healthcare providers are taking care of one patient. Thus, a team of healthcare provider users may be associated with a patient, and the team of users may be notified of medical information regarding that particular patient as the information becomes available.

In one illustrative embodiment, the messaging system includes a central server and a plurality of user devices or user devices that are used by healthcare providers to receive messages. For added availability and responsiveness, the central server can include a server farm with an array of load-balanced servers and may be geographically distributed. The server(s) and user devices may be connected via an IP (Internet Protocol) based network and use both secure instant messaging (SIM) such as but not limited to Extensible Messaging and Presence Protocol (XMPP) and also web-based technologies, such as but not limited to PHP and JavaScript. The communication channels between the server(s) and the user devices may be encrypted by SSL (Secure Socket Layer) to ensure the confidentiality of the delivered messages and their content. Additional security is optional and can also be added by adding more encryption layer(s) as needed. A client, or user, device can be a smart cellular phone, a portable digital assistant (PDA), a tablet personal computer (PC), a laptop PC, a desktop PC or other suitable device. The user device may be equipped with a Web browser and/or other suitable interface to allow for messaging with the server and other functions for accessing medical information.

The messaging system may receive and process medical information for a plurality of patients from various sources, e.g., laboratory results from the laboratory, readings or analysis results from medical professionals, etc. Thus, for example, in a hospital setting, medical information may be received by the messaging system from sources both within and outside of the hospital. Such information may be stored by the messaging system, e.g., in a database or other suitable medical information store. Alternately, the messaging system need not necessarily store the medical information for a patient, but rather, may record the presence and location of the information so that appropriate healthcare providers may access the information directly from the source. For example, a laboratory testing service may send a message to the messaging service indicating that test results for a set of patients is complete, along with a list of patients. Actual data may be maintained on the laboratory service computers, and be accessed directly by user devices.

In response to receipt of an indication of medical information for a patient, the messaging system may generate and send a message(s) with the appropriate medical information data (e.g., text, sound, images, and/or video) to the appropriate healthcare providers associated with the patient through the secure communication channels described above. Accordingly, healthcare providers may review the medical information directly from the message. Alternately, the message may identify to the users that the medical information has been generated, and provide a way for the users to access the information, e.g., by including a computer actuatable link in the message that the user may implement to receive a detailed report of the medical information. Using the laboratory testing service example above, messages may be sent to users associated with patients in the list provided by the laboratory testing service indicating that test results are complete for one or more patients. The message may include a website link, computer file location or other suitable link that the user may employ to access the medical information, e.g., directly from the laboratory testing service computers via the Internet or other communications system. Along with such a link, the message may include a summary of the medical information included in a more detailed report accessed via the link, e.g., the message may indicate that the testing results are “negative” but for further details, the healthcare provider should access the detailed medical information report. By reviewing the summary, the user may determine whether review of the medical information is high priority or not.

The user may acknowledge receipt of the indication of medical information in a message in any suitable way. For example, the user may send a responsive message back to the messaging system, e.g., including a unique code or other identifier so that the messaging service can identify the message and/or the user, and the messaging system may record the acknowledgement. In another embodiment, a message sent from the messaging system may include a unique identifier in the form of both a URL (Uniform Resource Locator) and also a unique code which can be transmitted back to the messaging system by the user to acknowledge the receipt of the message. The messaging system may decode the URL and/or the unique code that is embedded in the message and keep a record of the acknowledgement. The messaging system may also be configured to ensure that users acknowledge not only receipt of a messaging identifying medical information for a patient, but also that the user actually reviewed the medical information. For example, a detailed report of medical information that is included in the message (or that is included in an attachment to the message, that is accessed by computer actuatable link, etc.) may include an acknowledgment button or other feature by which the user can acknowledge review.

In another embodiment, messages originally sent to users may be updated, e.g., in response to a change in medical information. Addenda of the initial messages can be made without altering the original message (although the medical information identified in the message may have changed in some way), and the user may be required to re-acknowledge the message addenda. Each message can also have a user-defined (e.g., optionally defined by radiologist, pathologist, etc.) priority, and depending on that priority, the message will be re-sent at a certain time interval based on user-defined priority rules in the case that one or more users do not acknowledge receipt of the message. According to these rules, after a defined period of time, a message that remains unacknowledged for a certain period may be resent to the user and/or be escalated in importance and sent to other users, such as an appropriate supervisor of a healthcare provider that has not acknowledged the message. Thus, the messaging system may guarantee delivery of the medical information. Undeliverable messages, e.g., because one or more users are not logged onto the messaging system or otherwise are unable to send/receive messages, may be stored in a queue which are delivered once the appropriate healthcare provider has logged in with a user device. Physical acknowledgement, though, may still be required as a part of this process, as a client device may be left ‘on’ without the healthcare provider actually receiving or reading the results.

In addition to sending a copy of medical information to a user, an optional copy may be sent to a printer, which is determined by the administrator of the system, to preserve a hard copy of the message and/or the medical information identified in the message. Electronic copies of the printed report may be archived in portable document format (PDF) and/or may be accessible using a website associated with the messaging system, e.g., by actuating a link included in a message sent to a healthcare provider user.

The messaging system may be equipped with a database system to store medical information from various sources as well as the rules for data processing and message generation, delivery and escalation (e.g., in the case of non-acknowledgment). For example, the messaging system may apply rules to medical information to generate a summary that is included with a message. For the safety of stored data, the database system may also be configured with data replication capabilities (e.g., a data archiving system) so it can restore data in the event of potential hardware or software failures.

Some advantages and/or features that may be provided by various embodiments in accordance with aspects of the invention are:
Although communications using a messaging system in accordance with the invention do not have to be encrypted, secure encrypted communication is an option that was previously unavailable in such a push delivery system for healthcare information.
The messaging system can confirm the online presence of a user before delivery of a message identifying medical information; if the user is not online, the message may be delivered as soon as recipient becomes online
Unlike other message systems for delivering healthcare results and information, aspects of the invention allow and/or require acknowledgement and confirmation of every message by users using multiple methods.
Message acknowledgement may be achieved by typing in a unique code generated by the SIM service which is sent back to the messaging system server and/or by clicking on a unique URL/acknowledgement button also generated by the SIM server, both of which may be included in the message.
Time/date stamp acknowledgement by recipient which is recorded by the messaging system server.

The inventors have also appreciated that healthcare providers would benefit from having the ability to receive updated patient medical information as the information changes, is added to, or is otherwise updated. Using conventional systems, healthcare providers have a difficult time identifying medical information that has been updated since a last review of a patient's record. However, the inventors have developed a feed-based information system for healthcare providers this is a significant advance over conventional healthcare information systems.

Internet-based subscriptions such as the Really Simple Syndication (RSS), Resource Description Framework (RDF), or Atom standards have been used as a way for users to gather general information about different websites in a centralized location. These feeds can be updated in an asynchronous fashion, and a user can aggregate different feeds using a specialized subscription or feed reader. Using this subscription-based model, efficiency of the reader is greatly enhanced as all the information is gathered to one place/computer. This subscription-based model also allows the user to customize the particular feeds he or she receives. The reader then polls the different sites at user-defined intervals that allow the updating of information. New, unread information is seen highlighted in a particular fashion (e.g., title in bold text) and old information is kept for as long as the reader deems necessary. This subscription-based model has revolutionized the way users are able to organize the myriad of information on the internet and aggregate this information into one organized application.

The United States federal government has within the last several years enacted the Health Insurance Portability and Accountability Act (HIPAA) to protect patient privacy with respect to their medical records and to allow easy access and portability of these records in case they change location of their medical care. Since the most commonly used methods for generating information feeds, such as RSS and Atom, are not secure and do not require authentication, these approaches may not be suitable for providing feeds of healthcare medical information. In one embodiment, the inventors have developed a secure RSS or other feed-based medical information system with authentication (password-protected) and encryption of data for disseminating medical information in the healthcare environment.

Aspects of the invention allow healthcare providers and others to subscribe to patient medical information. Using RSS, RDF, or Atom standards (referred hereafter as RSS to include all the different syndication formats), in one illustrative embodiment, a medical information system may create syndicated XML feeds that contain patient information. The feeds may be protected using either HTTPS/SSL encryption or HTTP Basic or Digest authentication, or another authentication method. The system may also keep track of the subscribers who access different patient feeds and when they have accessed the feed. If data remains unaccessed by one or more healthcare providers for a certain period of time, as defined by rules set by an administrator, the referring physician may be notified accordingly either using email or another electronic notification method such as XMPP. The feeds may be maintained for individual patients, and/or for services with respect to a group of patients, which may be especially useful in situations like intensive care units where the same healthcare providers administer to all patients in a particular location. Location, however, is not a limiting boundary for a clinical service. The one or more feeds may include many patients in different locations, such as a doctor's patient set that includes patients in different hospitals. Feeds based on services rather than patients may act to update clinicians on the recent updates of results based on time of all patients on a service, rather than simply only based on one patient. Thus, the feeds may conform more to the way a clinician has to manage multiple patients with multiple differing levels of needs at any given point.

The use of such a subscription-based system may also allow for easy portability of medical information. A patient may request to take the entire medical record to another place, and this multimedia subscription-based model allows for easy export of this information either onto a portable storage medium, such as a CDROM or USB flash drive, or even on to a secure website where the patient's new healthcare providers may access and download that information, and eventually import it into another hospital's information system.

Due to the large amount of PHI (patient healthcare information) that a healthcare provider has to continuously keep track of, a system using this subscription-based model would greatly enhance the efficiency with which healthcare providers can access and organize PHI. Using this system with standard desktop computers or laptops, or with newer wireless PDA's would allow them more conveniently access this data in time-critical and life-saving situations, thereby improving patient care and decreasing medical error.

The invention may use an RSS feed to provide not only text information, but also audio and video data, and may include (but is not limited to) patient allergies, medications, physical exam, other statistics (including but not limited to vital signs, laboratory values, height, weight, body mass index and so on), laboratory results, radiology results, pathology results, and surgical or procedural reports. In addition, using RSS enclosure methods, other forms of media can be included such as voice dictation, photos of pathology, radiology, or surgery, and videos. In addition, forms with patient signatures and also didactic material can be attached. In this way, the total patient medical record, not just the text portions, can be accessed using this single method of aggregation in a secure fashion.

In addition to aggregating the patient information for convenient clinician access, aspects of the invention can also allow for the export of the different patient feeds into other formats such as portable document format (PDF), rich text format (RTF), and XML formats, so that they can easily and conveniently be transported to another doctor's office or hospital. This export feature allows for easy downloading and archiving of a patient's own medical record and interface with other hospital information systems which support these subscription services. Some of the export formats may not contain all the different types of multimedia allowed in the flexible RSS format.

Other features and/or advantages that may be offered by embodiments in accordance with aspects of the invention include:
although the data does not have to be encrypted, secure encrypted data is an option for feeds;
more convenient access and updates than non-subscription based methods;
different methods of organization (e.g., by patient service) rather than just by patient, which may allow for different types of analysis by clinicians;
storage of multimedia data as described, not just text data;
easy archiving or exporting to other computerized formats which gives patient more flexibility and mobility
an option for data to be stored offline on a computer or portable device (e.g., PDA) for analysis by clinician even when not directly connected to our invention's servers (security of computer or PDA then becomes responsibility of the clinician).

### BRIEF DESCRIPTION OF THE DRAWINGS

Aspects of the invention are described with reference to illustrative embodiments and the following figures in which like numerals reference like elements, and wherein:

FIG. 1 is a schematic block diagram of a medical information system in accordance with aspects of the invention;

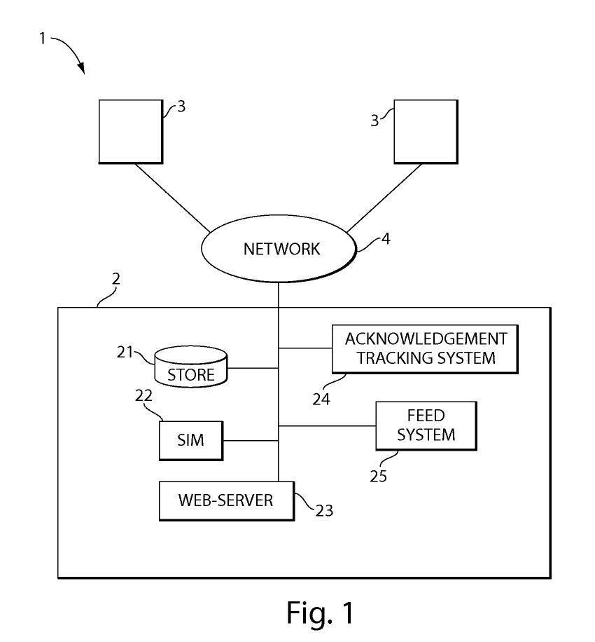

FIG. 2 is a flow chart of steps for updating a report for a patient's medical information; and

FIG. 3 is a flow chart of steps for sending a message to a user and receiving acknowledgment.

### DETAILED DESCRIPTION

Aspects of the invention are described with reference to illustrative embodiments, but it should be understood that aspects of the invention are not limited to the embodiments described herein. Also, aspects of the invention may be used alone, and/or in combination with any other suitable aspects of the invention.

Error! Reference source not found depicts a schematic block diagram of a computerized event notification system 1 in one illustrative embodiment. The system 1 in this embodiment includes a computer system 2, a number of client or user devices 3 (e.g., used by healthcare providers and/or patients) and a network 4 that allows the computer system 2 and user devices 3 to communicate. The network 4 may include any suitable wired and/or wireless communication system, such as a WLAN, LAN, the Internet, personal area network(s), cellular telephone network(s), and so on. In this illustrative embodiment, the computer system 2 and user devices 3 may communicate via a IP (Internet Protocol)-based network and secure instant messaging (SIM), such as but not limited to Extensible Messaging and Presence Protocol (XMPP). The communication channels between the computer system 2 and the user devices 3 may be encrypted by SSL (Secure Socket Layer) or other suitable arrangement to ensure the confidentiality of the delivered messages. This or other additional security is optional and can also be added by adding more encryption layer(s) as needed. A client device 3 can be a smart cellular phone, a portable digital assistant (PDA), a tablet personal computer (PC), a laptop PC, a desktop PC or other suitable device. The user device 3 may be equipped with a Web browser, a messaging client and/or other suitable software and hardware to interface with the computer system 2 and perform desired functions.

The computer system 2 may include one or more general purpose or other computers (e.g., one or more servers) which may be located in a single physical location and/or may be distributed over any suitable geographical area. If distributed, devices in the computer system 2 may communicate via the network 4 and/or any other suitable communication system. The computer system 2 in this embodiment includes a medical information store 21, which may include one or more computer data storage devices (magnetic disc memory, optical storage, and/or any other volatile or non-volatile memory) and which may store any suitable medical information, such as radiology and laboratory test results, or other medical information such as clinician notes, consultation notes, vital signs, procedural or operating reports, medication updates, allergy warnings, physical exam notes, voice or sound notes, images, video clips. Medical information may be stored in any suitable arrangement, such as a database, standard file format, a proprietary format and/or any suitable combination of arrangements.

The computer system 2 may also include a messaging system 22, e.g., in this embodiment a Secure Instant Messaging system, for providing messages to user devices 3. A web-server 23 may also be included in the computer system 2 for handling web pages and other Internet-based providing/gathering of medical information as discussed herein, as well as performing other functions normally handled by a web server. Functions of the computer system 2 may be provided by any suitable set of software code or other instructions (herein software modules), such as an acknowledgement tracking system 24 and medical information feed system 25, and may operate on any suitable device using any suitable operating system, etc.

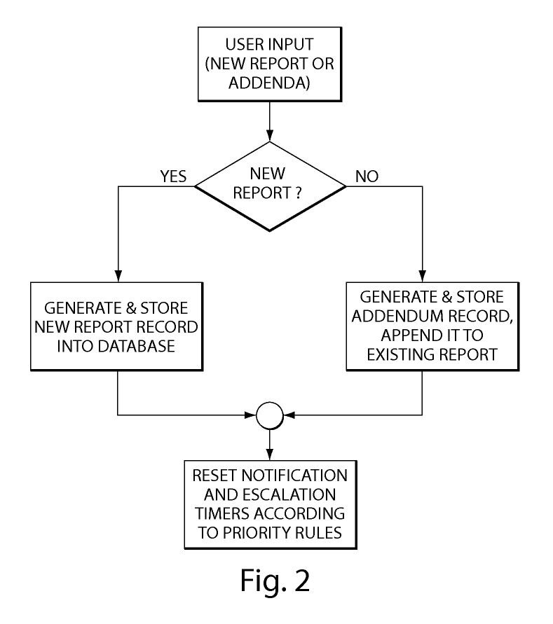

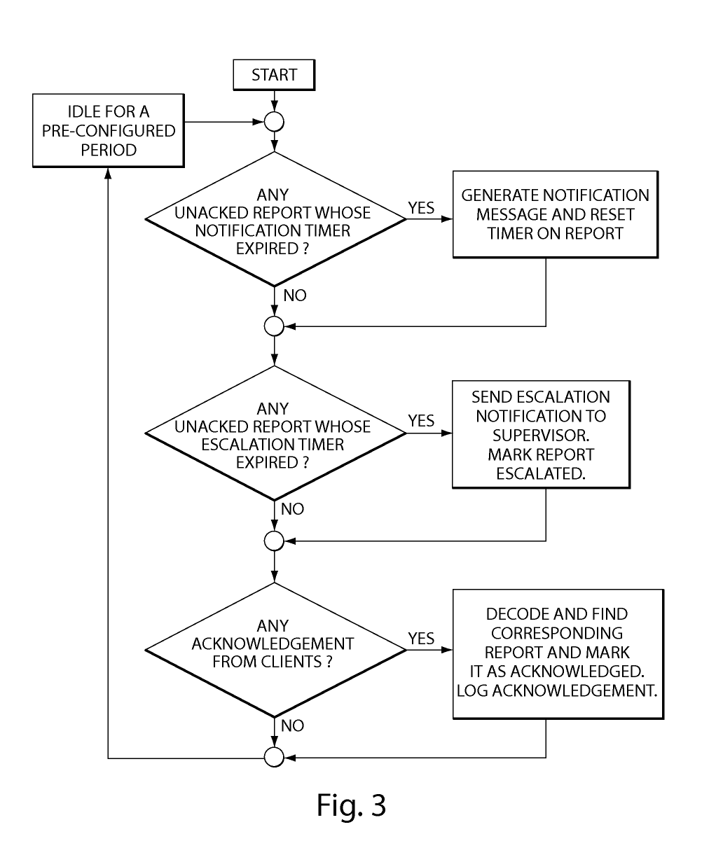

FIG. 2 illustrates a process the messaging system 22 may follow when the computer system 2 receives a new report or an addendum to an existing report regarding medical information. To enter or otherwise provide the new report or an addendum to the computer system 2 and the store 21, a user may use a client device 3 to enter the required information through a Web-based interface managed by the Web-server 23. Once the computer system 2 receives the new report, the computer system 2 may either generate a new patient record in the medical information store 21 or establish an addendum and associate the addendum with an existing patient record in the store 21. For both new reports and addenda, the computer system 2 (e.g., the messaging system 22 and acknowledgement tracking system 24) may reset the notification and escalation timers according to the priorities in the new reports or addenda set by the user when entering the reports/addenda. These timers may be maintained as part of a patient record (e.g., as one or more fields of the record) and used to establish when messages are sent by the messaging system 22 to healthcare providers alerting them to the new information. For example, the acknowledgement tracking system 24 may recognize that a new patient report has not been reported to a set of users associated with the patient based on the notification timer, (e.g., a value having a “0” value) and instruct the messaging system 22 to send an appropriate message to the set of users including the newly received information. Upon sending the message, the acknowledgment tracking system 24 may update the corresponding record to indicate that notification has been sent, but not yet acknowledged. An escalation timer may be started for the message, and if acknowledgement does not occur before the escalation timer counts down to a specified value, e.g., “0”, the urgency of the message may be notched up and the message resent. When one or more users acknowledge receipt (e.g., the record may include multiple acknowledgement fields, one for each associated user), an appropriate update to the acknowledgement field may be made in the record. FIG. 3 explains how the timers are used for notification and escalation.

As shown in FIG. 3, once the system starts, the messaging system 22 and the acknowledgment tracking system 24 enter a processing loop, i.e., the system constantly processes queued events regarding incoming reports and/or messages to be sent. The messaging system 22 and acknowledgement tracking system 24 maintain a logical queue of events, which include the arrivals of the new reports and addenda, the receipts of acknowledgements of a report or addenda, the expirations of notification timers associated to new reports and addenda, the expirations of escalation timers, etc. Each event, once processed, is removed from the queue. The messaging system 22 and acknowledgment tracking system 24 become idle if there is no event in the queue.

When processing a queue event, the messaging system 22 and acknowledgement tracking system 24 may alter the records in the store 21 as a result.

For example, once the acknowledgement tracking system 24 (which may be implemented as part of the messaging system 22) receives an acknowledgement from a client, timers associated with the reports or addenda may be reset, and the report that has been acknowledged may be flagged in the database, e.g., by altering an “acknowledged” field in the corresponding database record. The messaging system 22 may also send proper messages to user devices 3 according to the type of event. If a queued event is the expiration of a notification timer for a report, the messaging system 22 may send a message or messages to the client(s) who subscribe(s) to the report.

In another aspect of the invention, the computer system 2 may function as both a feed generator and a feed aggregator, e.g., using the feed system 25 which may be implemented at least in part using known feed systems. The computer system 2 may have its own database system (e.g., the store 21) to store information aggregated from other feed servers or systems that may serve different purposes other than feed generation. When the feed system 25 communicates to another server of the same type (i.e., a feed generator or aggregator), the two may communicate with each other in the same feed format. The feed system 25 may also communicate with a system whose purpose is not to produce feeds, but serves a totally different purpose, in which case the feed server 25 serves as an “adaptor” that gathers and normalizes information from the non-feed-speaking systems and converts it into feeds. This way, the computer system 2 is capable of harvesting information in hospital information systems with heterogeneous devices and outputting the information in standard-conforming feeds. The feed server 25 may also provide a Web interface that a user can interact with to manage his or her own profile (including passwords) and feed subscriptions. All communications with the Web server may be encrypted by SSL (Secure Socket Layer) for security. The computer system 2 may include a user authentication and access control module to secure sensitive information, which could be a built-in part of the feed server 25 itself or can interface with the existing user access control system that has already been deployed and in use in the hospital.

The user device 3 may be equipped with a customized feed reader program. The feed reader may communicate with the feed system 25 and receive updates for subscribed feeds. Before being able to get updates from the computer system 2, the user may be required to log into the feed system 25 by providing a password, e.g., set up using the Web interface. The customized feed reader can also implement optional security layer with the computer system 2 for added security. Identification of feeds to be updated are determined by the subscriptions that each user has specified through the Web interface. Once the feed reader receives new feeds, it would alert the user by sound or other means for prompt actions.

In operation, a user may log onto a user device 3 (using a password and/or other security features), which in response may seek access to medical information feeds that the user has subscribed to. The feeds associated with the user may be accessed by the user device 3 and relevant information displayed on the user device 3. The user may select between one or more feeds, and once a feed is selected, a display may be generated that shows the feed name or other identifier, associated patients, other associated healthcare providers, information regarding which information in the feed the healthcare provided has already reviewed, and other data. Also, medical information that is new or otherwise changed since the user's last access to the feed may be highlighted or otherwise identified to the user. Thus, the user may be quickly directed to that new and/or different information. If the user has a particular feed “open” or active on his/her client device, the user may be alerted to changes in the feed, e.g., by sound, visual display, vibration of the device, etc. Highlighted or otherwise identified new/changed information may be clicked or otherwise acknowledged by the user, e.g., so the system can verify review of the new information and so the user can be sure that all new information has been reviewed.

The user may be enabled to custom define a feed for him/herself, e.g., by entering the patient ID, name or other identifier for one or more patients. Existing feeds may be changed, e.g., to drop a patient after the patient is discharged from hospital. In addition, or alternately, the user may be allowed to pick from one or more predefined feeds, e.g., a feed for the intensive care unit, a feed for the emergency room, a feed for the pediatric section, a feed for all patients admitted with a neurological disorder, etc. Again, these predefined feeds may be adjusted as desired.

1. An automated results or event notification system for a healthcare environment, comprising:
a remote user device having a messaging client and a unique account identification number; and
a computer system including:
a secure instant messaging system (SIM) that selectively transmits a message to one or more remote user devices using the remote user device's account identification number to cause the remote user device to display the message;
a web-server system that stores messages for the remote user device for access from a remote web-browser on a remote user device;
a medical information store that stores data representing results or other medical information relating to a patient received from different healthcare services; and
wherein the computer system, including the SIM, web-server system and medical information store, is configured to unsolicitedly, and without receiving instruction from the remote user device:
automatically receive data from other healthcare service computer systems,
automatically formulate a message for a remote user device in response to the data which may contain different levels of urgencies or importance as deemed by the healthcare service computer systems from which the data was received, and
automatically send the message to the remote user device in electronic format, together with the account identification number for the remote user device.

2. A system according to claim 1, wherein:
the data represents values of a patient statistic, results from a radiology exam, results from a pathology specimen, results from a surgical or other interventional procedure, or
the data is classified according to a priority or urgency based on guidelines set by each healthcare service computer system from which the data was received.

3. A system according to claim 1, wherein:
the SIM system generates a unique code for a particular message for a particular patient sent to a remote user device, and
wherein in response to the user providing the unique code to the user device, the SIM system generates information that the user can select to display the message for the patient at the remote user device; and
wherein the web-server system records a receipt of acknowledgement within a database with time and date stamp for the user(s) for the particular message for the particular patient.

4. A computerized, automated event notification system for a healthcare environment, comprising:
a medical information store that stores medical information in computer readable form for a plurality of patients;
a messaging system that selectively transmits an electronic message to at least one user associated with a patient, the message to be received by the user at a user device and including an indication of unacknowledged medical information related to the associated patient; and
an acknowledgement tracking system that receives and tracks acknowledgement messages from a user, an acknowledgement message representing that the user has received notice of medical information for a patient with whom the user is associated.

5. The system of claim 4, wherein the messaging system determines whether a user is logged into a user device before sending a message to the user, and wherein the acknowledgement tracking system receives an acknowledgement message from the user when the user accesses unacknowledged medical information.

6. The system of claim 4, wherein one or more users log onto the messaging system via a user device to receive and send messages, the messaging system being adapted to detect that a user is logged onto the system and, in response, to send a message to the user regarding medical information for a patient associated with the user that is stored in the medical information store.

7. The system of claim 4, wherein the messaging system communicates with user devices via a secure instant messaging system.

8. The system of claim 4, wherein a message sent to a user including medical information regarding a patient associated with the user includes a summary of a report included in medical information for the patient.

9. The system of claim 8, wherein the message includes a URL or other computer actuatable link to a detailed report related to the summary.

10. The system of claim 9, wherein actuation of the URL or other computer actuatable link by the user causes the user device to access a website to review medical information identified in the message.

11. The system of claim 4, wherein the message regarding medical information for a patient associated with the user includes a computer actuatable feature that when actuated by the user, sends an acknowledgement message verifying that the user has reviewed the message and/or its contents.

12. The system of claim 4, wherein if a user does not acknowledge receipt of a message, the messaging system resends the message one or more times.

13. The system of claim 4, wherein if a user does not acknowledge receipt of a message after a certain time interval, the messaging system sends the message to another user.

14. The system of claim 4, wherein the medical information store includes a plurality of distributed computer data storage devices.

15. The system of claim 14, wherein the plurality of distributed computer data storage devices are controlled and maintained by a plurality of different medical information generators.

16. The system of claim 4, wherein the medical information includes one or more of radiology results, laboratory results, clinician notes, consultation notes, patient vital signs, procedural or operating reports, medication updates, allergy warnings, physical exam notes, voice or sound notes, images, and/or video clips.

17. The system of claim 4, wherein user devices may be any one of a smart cellular phone, a portable digital assistant (PDA), a tablet personal computer (PC), a laptop PC, or a desktop PC.

18. An automated event notification system, comprising:
a medical information store that stores medical information for a plurality of patients; and
a medical information feed system that identifies medical information as being related to one or more medical information feeds and organizes the information into the one or more medical information feeds, the medical information feed system providing medical information regarding a medical information feed in electronic computer readable form to each user associated with the medical information feed, each medical information feed being associated with one or more patients.

19. The system of claim 18, further comprising:
an acknowledgement tracking system that tracks user access to medical information feeds to which each user is associated, and prompts the medical information feed system to send a message to the user when the user has not accessed a medical information feed for a time longer than a threshold.

20. The system of claim 18, wherein at least one medical information feed includes medical information related to a single patient or is associated with a group of patients.

21. The system of claim 18, wherein medical information in a medical information feed that is new and/or updated since a prior time when a user accessed the medical information feed is identified for review by the user.

22. The system of claim 18, wherein each user accesses medical information feeds via a user device by providing password information to the medical information feed system, which, in response to receipt of the password information, authenticates the user and sends medical information regarding feeds with which the user is associated.
